(19) United States
(12) Patent Application Publication
(10) Pub. No.: US 2026/0019026 A1
(43) Pub. Date: Jan. 15, 2026

(54) VERTICAL SUPPORT BEARING HOUSING FOR SOLAR TRACKER

(71) Applicant: Nextracker LLC, Fremont, CA (US)

(72) Inventors: Abhimanyu Anil Sable, Hyderabad (IN); Ricardo Delgado-Nanez, San Jose, CA (US)

(21) Appl. No.: 19/258,555

(22) Filed: Jul. 2, 2025

Related U.S. Application Data
(60) Provisional application No. 63/668,844, filed on Jul. 9, 2024.

(51) Int. Cl. H02S 20/32

(52) U.S. Cl. CPC H02S 20/32

(57) ABSTRACT

A solar tracker bearing housing includes a first bearing leg, a second bearing leg, and a bridge. The first bearing leg includes a first bearing leg first end and a first bearing leg second end, with the first bearing leg first end including a first bracket. The second bearing leg includes a second bearing leg first end and a second bearing leg second end, with the second bearing leg first end including a second bracket. The bridge extends between the first bearing leg second end and the second bearing leg second end, with the bridge including a pin receiving aperture. The first bearing leg, the second bearing leg, and the bridge are a single integral component.

### RELATED APPLICATIONS

This application claims the benefit of U.S. Provisional Patent Application No. 63/668,844, filed Jul. 9, 2024, the entire contents of which are incorporated herein by reference.

### TECHNICAL FIELD

This disclosure relates generally to device, system, and method embodiments for solar tracker bearing housings, such as integral solar tracker bearing housings. Certain such embodiments disclosed herein relate to a vertically supported bearing housing assembly that can be adapted to mount to a solar tracker support (e.g., a pair of piles; legs of a solar tracker A-frame; etc.).

### BACKGROUND

Solar panels can convert sunlight into energy. As an example, solar photovoltaic panels convert sunlight directly into electricity for a variety of applications. Solar panels are generally composed of an array of solar cells, which are interconnected to each other. The cells are often arranged in series and/or parallel groups of cells in series.

Solar tracker systems can be used to dynamically orient a plurality of solar modules, for instance, by moving the solar modules throughout the course of a given day to track the movement of the sun and thereby increase the efficiency and productivity of the solar modules. Typical solar tracker systems installed in the field support the solar modules at the ground surface using a bearing at a foundation component which is embedded at the ground surface. However, such typical solar tracker systems can necessitate a significant number of components and inter-component connections and fastening members to ultimately install the solar tracker system at the foundation, and, thus, can increase the cost associated with installing a solar tracker system and/or the cost associated with maintaining operation of a solar tracker system.

### SUMMARY

This disclosure in general describes embodiments of devices, systems, and methods relating to solar tracker bearing housing assemblies. Certain such embodiments disclosed herein relate to a vertically supported bearing housing assembly that can be adapted to mount to a multi-leg solar tracker support frame (e.g., a solar tracker A-frame). For instance, certain such embodiments disclosed herein include a bearing housing assembly that is configured to be mounted at a multi-leg solar tracker support frame to position a torque tube, and, when so mounted, hang the torque tube below an apex at the bearing housing assembly (e.g., below an apex at a bridge of vertically supported beating housing assembly at the multi-leg solar tracker support frame).

Such embodiments disclosed herein can be useful in reducing the cost, time, and labor associated with installing a solar tracker system in the field as well as useful in reducing the maintenance cost associated with operating a solar tracker system. For example, bearing housing embodiments disclosed herein can help to reduce the cost of solar tracker installation in the field by reducing a number of components and inter-component connections and fastening members necessary to effectively couple a bearing housing to a support foundation (e.g., to two legs of a multi-leg support frame, such as an A-frame support) of a solar tracker system. And, yet, in addition to such bearing housing embodiments disclosed herein allowing for cost reductions associated with solar tracker installation, bearing housing embodiments disclosed herein can provide a more structurally robust bearing housing that can bear, and transfer, increased loading at the bearing housing to the support foundation (e.g., to the legs of a multi-leg support frame). As another example, bearing housing embodiments disclosed herein can be configured to hang, or suspend, the solar tracker torque tube below an apex of a bridge of the bearing housing. This bearing housing configuration can lower the elevation of the torque tube and rotational axis of the solar tracker system, which in turn can help to reduce the magnitude of dynamic loads (e.g., wind loads) transferred to the foundation which can help to reduce the cost and complexity associated with foundations. Thus, the bearing housing embodiments disclosed herein can simultaneously provide a number of useful structural advantages which can synergistically reduce cost and complexity associate with solar tracker installation and operational maintenance.

One embodiment includes a solar tracker bearing housing. This solar tracker bearing housing embodiment includes a first bearing leg, a second bearing leg, and a bridge. The first bearing leg includes a first bearing leg first end and a first bearing leg second end, with the first bearing leg first end including a first bracket. The second bearing leg includes a second bearing leg first end and a second bearing leg second end, with the second bearing leg first end including a second bracket. The bridge extends between the first bearing leg second end and the second bearing leg second end, with the bridge including a pin receiving aperture. The first bearing leg, the second bearing leg, and the bridge are a single integral component.

In a further embodiment of this housing, the first bracket is integral to the first bearing leg and the second bracket is integral to the second bearing leg such that the first bearing leg, the first bracket, the second bearing leg, the second bracket, and the bridge are the single integral component. For instance, the first bearing leg, the second bearing leg, and the bridge can be the single integral component as formed from a single piece of sheet metal.

In a further embodiment of this housing, the first bracket defines a first bracket linear surface extending perpendicular to the bridge, and the second bracket defines a second bracket linear surface extending perpendicular to the bridge. The first bracket linear surface can face the second bracket linear surface, and the second bracket linear surface can face the first bracket linear surface. The first bracket linear surface can extend parallel to the second bracket linear surface. The pin receiving aperture can be located at the bridge between the first bracket linear surface and the second bracket linear surface. For some such examples, the first bearing leg first end can terminate at a first curved surface curving in a direction toward the second bearing leg first end, and the first bracket linear surface can extend linearly from the first curved surface. Similarly, the second bearing leg first end can terminate at a second curved surface curving in a direction toward the first bearing leg first end, and wherein the second bracket linear surface can extend linearly from the second curved surface. For one particular such example, the first curved surface can extend at a skewed angle to curve in the direction toward the second bearing leg first end, and the second curved surface can extend at a skewed angle to curve in the direction toward the first bearing leg first end. The first bracket can include two or more support frame mounting apertures below the pin receiving aperture and below the first curved surface, and the second bracket can include two or more support frame mounting apertures below the pin receiving aperture and below the second curved surface.

Another embodiment includes a solar tracker bearing system. This solar tracker bearing system embodiment includes a multi-leg solar tracker support frame, a bearing housing, and a pin. The multi-leg solar tracker support frame includes a first frame leg and a second frame leg. The bearing housing includes a first bearing leg, a second bearing leg, and a bridge. The first bearing leg includes a first bearing leg first end and a first bearing leg second end, with the first bearing leg first end including a first bracket that is configured to mount to the first frame leg. The second bearing leg includes a second bearing leg first end and a second bearing leg second end, with the second bearing leg first end including a second bracket that is configured to mount to the second frame leg. The bridge extends between the first bearing leg second end and the second bearing leg second end, and the bridge includes a pin receiving aperture. The first bearing leg, the second bearing leg, and the bridge are a single integral component. The pin extends through the pin receiving aperture at the bridge.

In a further embodiment of this system, the system further includes a first rail and a second rail. The first rail is at a first side of the bearing housing and coupled to the pin, and the second rail is at a second, opposite side of the bearing housing and coupled to the pin. The first rail can be configured to support a torque tube at the first side of the bearing housing, and the second rail can be configured to support a torque tube at the second, opposite side of the bearing housing. The first bracket can be integral to the first bearing leg and the second bracket can be integral to the second bearing leg such that the first bearing leg, the first bracket, the second bearing leg, the second bracket, and the bridge are the single integral component. The pin can couple the first rail to the bridge at the first side of the bearing housing and the pin can couple the second rail to the bridge at the second, opposite side of the bearing housing such that the pin couples the first rail and the second rail to the single integral component.

In a further embodiment of this system, the first bracket defines a first bracket linear surface extending perpendicular to the bridge, and the second bracket defines a second bracket linear surface extending perpendicular to the bridge. For example, the first bracket linear surface can faces the second bracket linear surface and the first bracket linear surface can extend parallel to the second bracket linear surface. The pin receiving aperture can be located at the bridge between the first bracket linear surface and the second bracket linear surface, and the first bearing leg first end can terminate at a first curved surface curving in a direction toward the second bearing leg first end, and the first bracket linear surface can extend linearly from the first curved surface. The second bearing leg first end can terminate at a second curved surface curving in a direction toward the first bearing leg first end, and the second bracket linear surface can extend linearly from the second curved surface. The first bracket can include two or more support frame mounting apertures below the pin receiving aperture and below the first curved surface, and the second bracket can include two or more support frame mounting apertures below the pin receiving aperture and below the second curved surface. The first rail can include two or more solar module mounting apertures at or above the pin receiving aperture, and the second rail can include two or more solar module mounting apertures at or above the pin receiving aperture.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is an elevational view diagram of an embodiment of a solar tracker system.

FIGS. 2A and 2B illustrate embodiments of a bearing housing coupled to different solar tracker supports. FIG. 2B is an elevational view showing the bearing housing coupled to a pair of piers. FIG. 2B is an elevational view showing the bearing housing coupled to a multi-leg solar tracker support frame.

FIGS. 3A-3D illustrate an embodiment of a solar tracker bearing system that includes a bearing housing, a pin, and a pair of rails. FIG. 3A is a perspective view of the system embodiment, FIG. 3B is a side elevational view of one side of the system embodiment, FIG. 3C is a side elevational view of another side (e.g., which is rotated ninety degrees from the side shown at FIG. 3B) of the system embodiment, and FIG. 3D is top plan view of the system embodiment.

FIG. 4 is cross-sectional view of a pin extending through a first embodiment of a pin receiving aperture at a bridge of a bearing housing and to each of a pair of rails at opposite sides of the bearing housing.

FIG. 5 is a cross-sectional view of a pin extending through a second embodiment of a pin receiving aperture at a bridge of a bearing housing and to each of a pair of rails at opposite sides of the bearing housing.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein include various devices, systems, and methods relating to relating to solar tracker bearing housing assemblies. Certain such embodiments disclosed herein relate to a vertically supported bearing housing assembly that can be adapted to mount to a multi-leg solar tracker support frame. For instance, certain such embodiments disclosed herein include a bearing housing assembly that is configured to be mounted at a multi-leg solar tracker support frame to position a torque tube, and, when so mounted, hang the torque tube below an apex at the bearing housing assembly (e.g., below an apex at a bridge of vertically supported beating housing assembly at the multi-leg solar tracker support frame). Such embodiments disclosed herein can be useful in reducing the cost, time, and labor associated with installing a solar tracker system in the field as well as useful in reducing the maintenance cost associated with operating a solar tracker system.

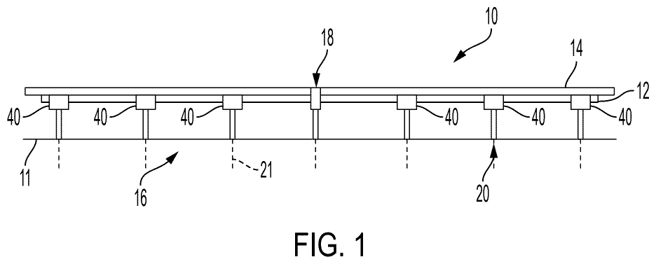

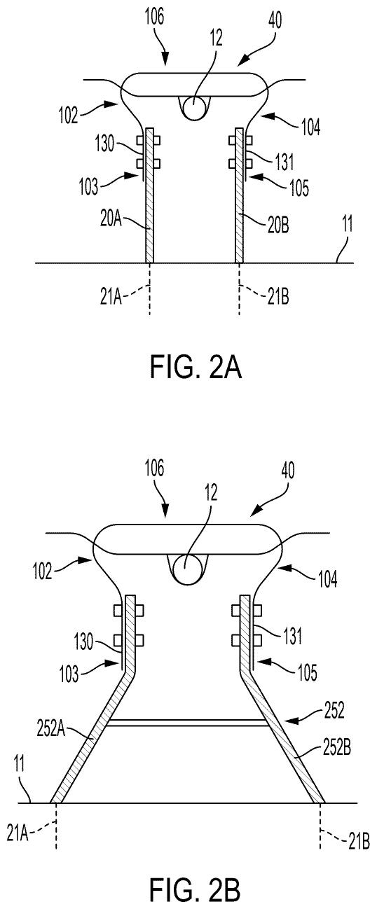

FIG. 1 is an elevational view diagram of a solar tracker system 10. FIG. 1 shows the system 10 at a side elevational view looking in an east-west orientation at the system 10. In some applications, a plurality of solar trackers 10 may be arranged in a north-south longitudinal orientation to form a solar array. The solar tracker system 10 includes a plurality of solar tracker support frame legs, or piers, 20 disposed in spaced relation to one another and embedded in the earth. A torque tube 12 extends between each adjacent pier 20 and is rotatably supported at each pier 20. The solar tracker 10 includes a plurality of solar modules, or panels, 14 supported on each respective torque tube 12. The span between two adjacent piers 20 is referred to as a bay 16 and may be generally in the range of about 8 meters in length. As shown at the examples at FIGS. 2A and 2B, solar tracker support frame legs, or piers, 20 can be supported at a ground surface 11 via one or more foundation components 21 (e.g., subterranean pile). The foundation components 21 can extend into and below ground surface 11 so as to be embedded into the ground surface 11 to support the above-ground, respective solar tracker support frame legs, or piers, 20 and associated respective bearing housings 40. The foundation components 21 can, for example, one or more blade piles (e.g., a pair of blade piles), one or more screw piles (e.g., a pair of screw piles), and/or one or more concrete footings (e.g., a pair of concrete footings) as examples.

The solar tracker 10 includes at least one motive source (e.g., motor, slew drive, etc.) 18 operably coupled to the torque tube 12 and supported on a respective pier 20 of the plurality of piers 20. The motive source 18 effectuates rotation of the torque tube 12, which effectuates a corresponding rotation of the solar panels 14 to track the location of the sun. The solar tracker 10 includes a plurality of bearing housings 40 coupled to respective piers of the plurality of piers 20. Each of the plurality of bearing housings 40 is operably coupled to the torque tube 12 to rotatably support the torque tube 12 therein as the torque tube 12 is caused to be rotated by the slew drive 18.

Installing a typical solar tracker system in the field can oftentimes necessitate a significant number of interconnections between a significant number of components ranging from subterranean foundation components and connections to above-ground bearing connections and solar module support connections. Moreover, once such components are assembled at installed at the solar tracker system as designed, the load baring capacity of certain such assembled and installed components can be insufficient for the actual operational load borne during operation of the solar tracker system. The solar tracker bearing housing embodiments disclosed herein can be useful in reducing the cost, time, and labor associated with installing a solar tracker system in the field while yet also helping to increase the weight bearing capacity of such bearing housings when used in operation at the solar tracker system. For some embodiments, the integral bearing housing can be configured to rotatably support the torque tube hanging, or suspended, below an apex of a bridge at the bearing housing with the bearing housing vertically transferring a load from the torque tube to the legs of the multi-leg solar tracker support frame or adjacent pier as appropriate for the particular application.

When applied to solar tracker applications, the bearing housing embodiments disclosed herein can be used with a variety of solar tracker supports to support the bearing housing at the ground surface. For example, the bearing housing embodiments disclosed herein can be coupled to one or more, such as a pair of, piles/piers (e.g., vertical piles/piers) which are embedded in the ground surface (e.g., via a respective pair of subterranean piles/piers). As another example, the bearing housing embodiments disclosed herein can be coupled to a multi-leg solar tracker support frame, such as an A-frame, which multi-legs are embedded in the ground surface (e.g., via a respective pair of subterranean piles). FIGS. 2A-2B illustrate exemplary solar tracker applications of bearing housing 40. Namely, FIGS. 2A and 2B illustrate an embodiment of bearing housing 40 at different embodiments of a solar tracker support frame.

FIG. 2A is an elevational view illustrating one exemplary embodiment where bearing housing 40 is coupled to a pair of piers-first pier 20A and second pier 20B. First pier 20A and second pier 20B can each be embedded in within the ground surface 11. For example, a first subterranean pile 21A can be embedded in the ground and first pier 20A can be coupled to first subterranean pile 21A to thereby anchor first pier 21A in the ground. Likewise, a second subterranean pile 21B can be embedded in the ground and second pier 20B can be coupled to second subterranean pile 21B to thereby anchor second pier 20B in the ground.

Bearing housing 40 can be coupled to the first pier 20A and the second pier 20B to thereby support bearing housing 40 at the ground. A first side of bearing housing 40 can be coupled to the first pier 20A, and a second, opposite side of bearing housing 40 can be coupled to the second pier 20B. As such, bearing housing 40 can extend, or bridge, between the first and second piers 20A, 20B. In this way, bearing housing 40 can serve as a type of cap placed between (e.g., over and between) two adjacent piers 20A, 20B. Bearing housing 40 can receive torque tube 12 and rotatably support torque tube 12 thereat. Torque tube 12 can rotate relative to the bearing housing 40 to cause an angular orientation of the solar modules, supported at torque tube 12, to change throughout a day to track the position of the sun.

As will be described in further detail later herein, the bearing housing 40 can include a first bearing leg 102 and a second bearing leg 104. The first bearing leg 102 can include a first bracket 103 that is configured to mount to the first pier 20A, and the second bearing leg 104 can include a second bracket 105 that is configured to mount to the second pier 20B. The bearing housing 40 can further include a bridge 106 that extends between the first bearing leg 102 and the second bearing leg 104. As shown at FIG. 2A, when the first bracket 103 is mounted to the first pier 20A and the second bracket 105 is mounted to the second pier 20B, the bearing housing 40 bridges between the first and second piers 20A, 20B.

FIG. 2B is an elevational view illustrating another exemplary embodiment where bearing housing 40 is coupled to a multi-leg solar tracker support frame 252 that includes a first leg 252A and a second leg 252B. As illustrated at FIG. 2B, the multi-leg solar tracker support frame 252 can generally form an A-frame with the bearing housing 40 as a type of “cap” at the A-frame legs 252A, 252B.

First leg 252A and second leg 252B can each be embedded in within the ground surface 11. For example, a first subterranean pile 21A can be embedded in the ground and first leg 252A can be coupled to first subterranean pile 21A to thereby anchor first leg 252A in the ground. Likewise, a second subterranean pile 21B can be embedded in the ground and second leg 252B can be coupled to second subterranean pile 21B to thereby anchor second leg 252B in the ground.

Bearing housing 40 can be coupled to the first leg 252A and the second leg 252B to thereby support bearing housing 40 at the ground. A first side of bearing housing 40 can be coupled to the first leg 252A, and a second, opposite side of bearing housing 40 can be coupled to the second leg 252B. As such, bearing housing 40 can extend, or bridge, between the first and second legs 252A, 252B. In this way, bearing housing 40 can serve as a type of cap placed between (e.g., over and between) two adjacent legs 252A, 252B (e.g., two adjacent A-frame legs 252A, 252B). Bearing housing 40 can receive torque tube 12 and rotatably support torque tube 12 thereat. Torque tube 12 can rotate relative to the bearing housing 40 to cause an angular orientation of the solar modules, supported at torque tube 12, to change throughout a day to track the position of the sun.

As will be described in reference to FIG. 2A and as will be described in further detail later herein, the bearing housing 40 can include first bearing leg 102 and second bearing leg 104. The first bearing leg 102 can include first bracket 103 that is configured to mount to the first leg 252A, and the second bearing leg 104 can include second bracket 105 that is configured to mount to the second leg 252B. The bearing housing 40 can further include bridge 106 that extends between the first bearing leg 102 and the second bearing leg 104 such that, as shown at FIG. 2B, when the first bracket 103 is mounted to the first leg 252A and the second bracket 105 is mounted to the second leg 252B, the bearing housing 40 bridges between the first and second legs 252A, 252B.

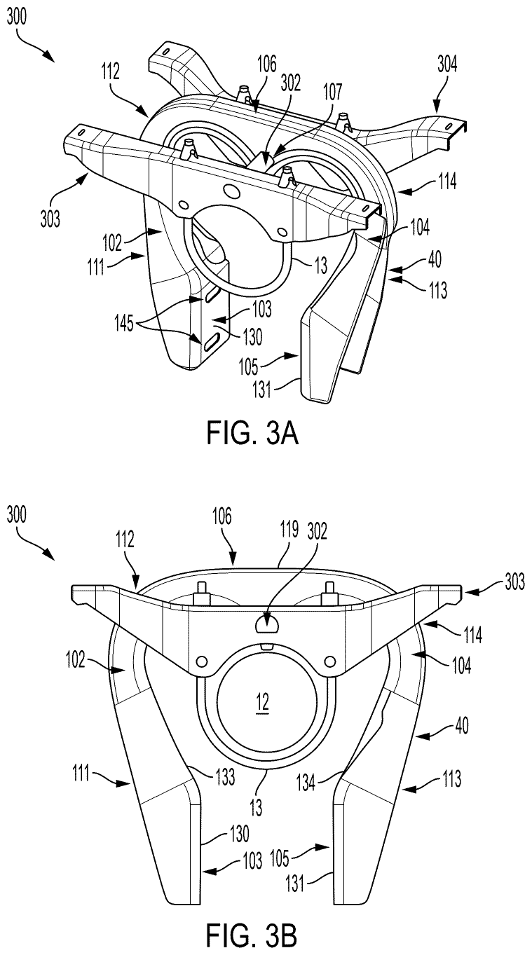

FIGS. 3A-3D illustrate an embodiment of a solar tracker bearing system 300. The solar tracker bearing system 300 can include the bearing housing 40, a pin 302, and a pair of rails 303, 304. Some embodiments of the solar tracker bearing system 300 can additionally include one or more solar tracker supports to which the bearing housing 40 can be coupled (e.g., multi-leg solar tracker support frame 252; a pair of piers 20A, 20B). FIG. 3A is a perspective view of the system 300, FIG. 3B is a side elevational view of one side of the system 300, FIG. 3C is a side elevational view of another side (e.g., which is rotated ninety degrees from the side shown at FIG. 3B) of the system 300, and FIG. 3D is top plan view of the system 300.

The bearing housing 40 can be a single integral component. As one example, the bearing housing 40 can be formed from a single workpiece, such as a single piece of sheet of metal, which can be shaped (e.g., bent) to form the single piece, integral bearing housing 40. As noted previously, the bearing housing 40 can include the first bearing leg 102, the second bearing leg 104, and the bridge 106. As such, when the bearing housing 40 is a single integral component, the first bearing leg 102, the second bearing leg 104, and the bridge 106 can be a single integral component. More specifically, as noted previously, the first bearing leg 102 can include first bracket 103 and the second bearing leg 104 can include second bracket 105 such that, when the bearing housing 40 is a single integral component, the first bearing leg 102, the first bracket 103, the second bearing leg 104, the second bracket 105, and the bridge 106 can be a single integral component. Namely, when the bearing housing 40 is a single integral component, the first bracket 103 can be integral to the first bearing leg 102 and the second bracket 105 can be integral to the second bearing leg 104 such that the first bearing leg 102, the first bracket 103, the second bearing leg 104, the second bracket 105, and the bridge 106 are a single integral component.

One useful advantage of single piece, integral bearing housing 40 is that bearing housing 40 can be shaped to vertically bear, and transfer, loads to an adjacent ground support (e.g., pile/pier/leg of solar tracker support) via the integral first and second brackets 103, 105. The ability of the single piece, integral bearing housing 40 to transfer (e.g., vertically transfer) loads to the adjacent ground support through the integral first and second brackets 103, 105 can help to increase the operational load bearing capacity associated with the bearing housing 40. Another useful advantage of single piece, integral bearing housing 40 is that integral bearing housing 40 can provide useful cost advantages in costs of goods, manufacturing efficiencies, and/or installation on site at a solar tracker system (e.g., by eliminating laborious, manual fastening connections otherwise needed during installation between separate bearing housing components).

As shown at FIGS. 3A-3D, the bearing housing 40 can include the first bearing leg 102, the second bearing leg 104, and the bride 106 that extends between the first and second bearing legs 102, 104. The first bearing leg 102 can include a first bearing leg first end 111 and a first bearing leg second end 112, and the second bearing leg 104 can include a second bearing leg first end 113 and a second bearing leg second end 114. The first bearing leg first end 111 can include the first bracket 103, and the second bearing leg first end 113 can include the second bracket 105. The bridge 106 can extend between the first bearing leg second end 112 and the second bearing leg second end 114.

The bearing housing 40 can couple to and support one or more other solar tracker system components. As noted, the system 300, in addition to the bearing housing 40, can include the pin 302 and the pair of rails 303, 304. Bearing housing 40 can receive the pin 302, and the pair of rails 303, 304 can couple to the pin 302 such that the bearing housing 40 supports the pair of rails 303, 304 via the pin 302. The pin 302 can further support the torque tube 12 at the bearing housing 40 (e.g., as shown at FIG. 3B). More particularly, the torque tube 12 can be received at a bracket 13 at each of the rails 303, 304 such that the pin 302 couples the torque tube 12 to each opposite side of the bearing housing 40 via the brackets 13 such that torque tube 12 can rotate relative to bearing housing 40.

The bridge 106 can include a pin receiving aperture 107. The pin receiving aperture 107 can be configured to receive the pin 302 thereat. As such, pin 302 can extend out from the pin receiving aperture 107 at each side of the bridge 106 to couple the pin 302 to other, non-bearing housing components, such as the pair of rails 303, 304 and/or the torque tube 12. The bridge 106 can define a bridge apex 119 (e.g., shown at FIG. 3B), which can be the highest elevation surface at the bridge 106 above the ground surface. The pin 302 can extend through the bridge 106, at the pin receiving aperture 107, below the bridge apex 119. The bearing housing 40 (e.g., integral bearing housing 40) can thus be configured to hang, or suspend, torque tube 12, between the first and second bearing legs 102, 104 and below the bridge apex 119. The vertical load transferring, integral bearing housing 40 can be well suited to accommodate the loading applied to the bearing housing 40 as a result of this torque tube suspending from the below the bridge 106.

The first bracket 103 and the second bracket 105 can each be configured to couple the bearing housing 40 to a solar tracker support, such as, respectively, to a pier of a pair of piers or to a leg of a multi-leg solar tracker support. To help couple to the solar tracker support(s), the first and second brackets 103, 105 can include one or more support frame mounting apertures 145. For example, the illustrated embodiment shows that the first bracket 103 can include at least two support frame mounting apertures 145, and the second bracket 105 can likewise include at least two support frame mounting apertures 145. The support frame mounting apertures 145 included at the first and second brackets 103, 105 can be elongated in one or more directions to provide for misalignment tolerance when coupling the bearing housing 40 to the adjacent support(s). The illustrated embodiment shows the pin 302 extending in a north-south direction with the rails 303, 304 extending in an east-west direction; as shown here the support frame mounting apertures 145 included at the first and second brackets 103, 105 can be elongated in a north-south direction (e.g., elongated in the same direction that the pin 302 extends through the bridge 106) to provide installation tolerance in the north-south direction when coupling bearing housing 40 to adjacent support(s).

Each of the first bracket 103 and the second bracket 105 can extend generally vertically (e.g., relative to the ground surface) and thus be generally parallel to the adjacent solar tracker support (e.g., the first bracket 103 can extend parallel to a first pier/leg and the second bracket 105 can extend parallel to a second pier/leg). This vertical orientation of the first and second brackets 103, 105 can thus orient the first and second brackets 103, 105 parallel to the adjacent solar tracker support and thereby allow for a vertically extending coupling interface between the first bracket 103 and a first, adjacent solar tracker support component (e.g., a first pier/leg) and a vertically extending coupling interface between the second bracket 105 and a second, adjacent solar tracker support component (e.g., a second pier/leg).

With the vertical orientation of the first and second brackets 103, 105, the first bracket 103 can define a first bracket linear surface 130 that extends perpendicular to the bridge 106, and the second bracket 105 can define a second bracket linear surface 131 that extends perpendicular to the bridge 106. The first bracket linear surface 130 can face the second bracket linear surface 131, and the first bracket linear surface 130 can extend parallel to the second bracket linear surface 131. The pin receiving aperture 107 can be located at the bridge 106 between the first bracket linear surface 130 and the second bracket linear surface 131.

As seen best at FIG. 3B, the first bearing leg first end 111 can terminate at a first curved surface 133 that curves in a direction toward the second bearing leg first end 113, and the second bearing leg first end 113 can terminate at a second curved surface 134 that curves in a direction toward the first bearing leg first end 111. The first bracket linear surface 130 can extend linearly from an end of the first curved surface 133, and the second bracket linear surface 131 can extend linearly from an end of the second curved surface 134. The support frame mounting apertures 145 at the first bracket 103 can be located below the pin receiving aperture 107 and below the first curved surface 133 (e.g., below a lower end of the first curved surface 133). And the support frame mounting apertures 145 at the second bracket 105 can be located below the pin receiving aperture 107 and below the second curved surface 134 (e.g., below a lower end of the second curved surface 134). As one particular such example shown for the illustrated embodiment, the first curved surface 133 can extend at a skewed angle to curve in the direction toward the second bearing leg first end 113, and the second curved surface 134 can extend at a skewed angle to curve in the direction toward the first bearing leg first end 111.

Thus, the curved surfaces 133, 134 defined by the first and second bearing leg first ends 111, 113 can create an internal area therebetween large enough to receive the torque tube 12, which hangs down from the bridge 106, while the geometry of the bearing housing changes at the ends of these curved surfaces 133, 134 to provide the first bracket vertical, linear surface 130 and the second bracket vertical, linear surface 131 configured to transfers loading applied at the bearing housing 40.

When the bearing housing 40 is coupled to adjacent solar tracker support(s) (e.g., such as shown at the examples at FIGS. 2A and 2B, which illustrate bearing housing 40 coupled to different, exemplary solar tracker supports), the bearing housing 40 can be part of solar tracker bearing system 300. Solar tracker bearing system 300 can include, in addition to the bearing housing 40, the pin 302 and the pair of rails 303, 304. The first bearing leg 102 can be configured to mount to a first pier/leg at the first bracket 103 at the first bearing leg first end 111, and the second bearing leg 104 can be configured to mount to a second pier/leg at the second bracket 105 at the second bearing leg first end 113. First rail 303 can be at a first side of the bearing housing 40 and coupled to the pin 302, and second rail 304 can be at a second, opposite side of the bearing housing 40 and coupled to the pin 302. The first rail 303 can be configured to support torque tube 12 (e.g., via bracket 13) at the first side of the bearing housing 40, and the second rail 304 can be configured to support torque tube 12 at the second, opposite side of the bearing housing 40. Thus, the pin 302 can be configured to couple the first rail 303 to the bridge 106 at the first side of the bearing housing 40, and the pin 302 can be configured to couple the second rail 304 to the bridge 106 at the second, opposite side of the bearing housing 40 such that the pin 302 couples the first rail 303 and the second rail 304 to the single integral component bearing housing 40.

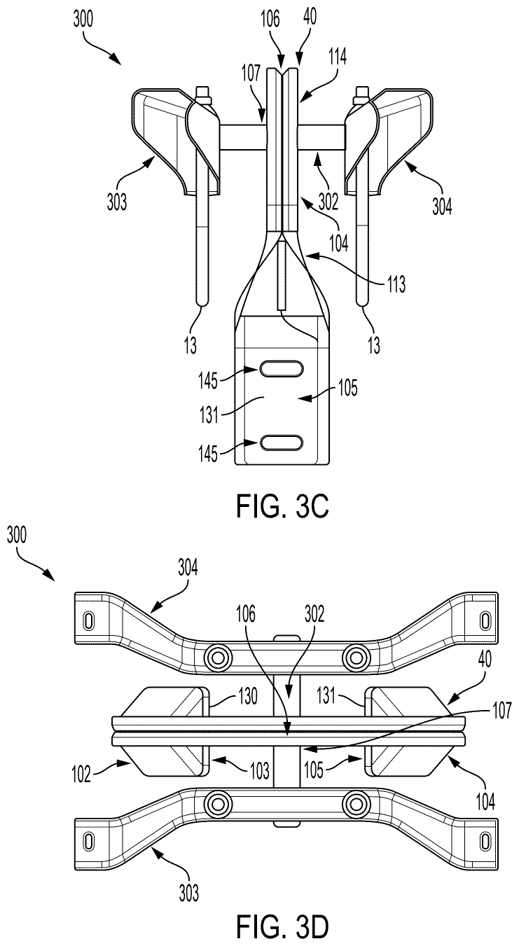

FIG. 4 is cross-sectional view of pin 302 extending through a first embodiment of a pin receiving aperture 107 at bridge 106 of bearing housing 40 and to each of a pair of rails 303, 304 at opposite sides of the bearing housing 40. As shown for the pin receiving aperture 107 embodiment at FIG. 4, the pin receiving aperture 107 can be defined at an upper portion by intermediate bridge wall 401 and at an opposite lower portion by a pair of bridge pin support flanges 402, 403. Thus, for the example at FIG. 4, as the pin 302 extends through the bridge 106 at the pin receiving aperture 107, the pin 302 can be supported at an upper side of the pin 302 by an end surface of the intermediate bridge wall 401 and be supported at a lower side of the pin 302 by each of the two pin support flanges 402, 403. For both accommodating reception of the pin 302 and supporting the pin 302, each of the pin support flanges 402, 403 can have an outer radial end surface, furthest from the intermediate bridge wall 401, that curves downward toward ground surface and away from the end surface of the intermediate bridge wall 401 that interfaces with the upper portion of the pin 302.

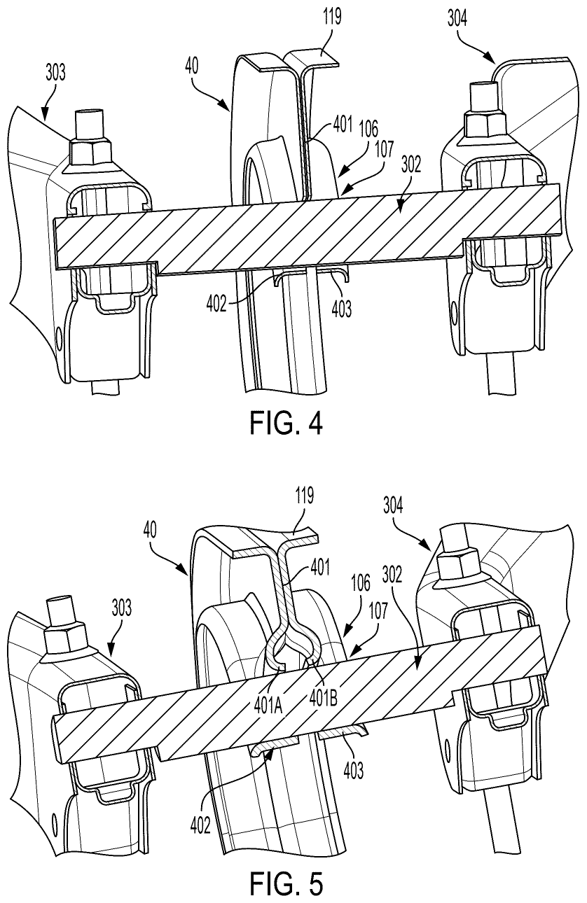

FIG. 5 is a cross-sectional view of pin 302 extending through a second embodiment of pin receiving aperture 107 at bridge 106 of bearing housing 40 and to each of a pair of rails 303, 304 at opposite sides of the bearing housing 40. As shown for the pin receiving aperture 107 embodiment at FIG. 5, the pin receiving aperture 107 can be defined at an upper portion by a pair of upper bridge pin support flanges 401A, 401B, which can form an end surface of the intermediate bridge wall 401, and at an opposite lower portion by the pair of bridge pin support flanges 402, 403. Thus, for the example at FIG. 5, as the pin 302 extends through the bridge 106 at the pin receiving aperture 107, the pin 302 can be supported at an upper side of the pin 302 by the pair of upper bridge pin support flanges 401A, 401B and be supported at a lower side of the pin 302 by each of the two pin support flanges 402, 403. For both accommodating reception of the pin 302 and supporting the pin 302, each of the upper bridge pin support flanges 401A, 401B and each of the pin support flanges 402, 403 can have an outer radial end surface, furthest from the intermediate bridge wall 401, that curves downward toward ground surface and away from the end surface of the intermediate bridge wall 401 that interfaces with the upper portion of the pin 302.

Various examples have been described. These and other examples are within the scope of the following claims.

What is claimed is:

1. A solar tracker bearing housing comprising:
a first bearing leg comprising a first bearing leg first end and a first bearing leg second end, the first bearing leg first end including a first bracket;
a second bearing leg comprising a second bearing leg first end and a second bearing leg second end, the second bearing leg first end including a second bracket; and
a bridge extending between the first bearing leg second end and the second bearing leg second end, the bridge comprising a pin receiving aperture,
wherein the first bearing leg, the second bearing leg, and the bridge are a single integral component.

2. The housing of claim 1, wherein the first bracket is integral to the first bearing leg and the second bracket is integral to the second bearing leg such that the first bearing leg, the first bracket, the second bearing leg, the second bracket, and the bridge are the single integral component.

3. The housing of claim 1, wherein the first bracket defines a first bracket linear surface extending perpendicular to the bridge, wherein the second bracket defines a second bracket linear surface extending perpendicular to the bridge.

4. The housing of claim 3, wherein the first bracket linear surface faces the second bracket linear surface.

5. The housing of claim 4, wherein the first bracket linear surface extends parallel to the second bracket linear surface.

6. The housing of claim 5, wherein the pin receiving aperture is located at the bridge between the first bracket linear surface and the second bracket linear surface.

7. The housing of claim 6,
wherein the first bearing leg first end terminates at a first curved surface curving in a direction toward the second bearing leg first end, and wherein the first bracket linear surface extends linearly from the first curved surface, and
wherein the second bearing leg first end terminates at a second curved surface curving in a direction toward the first bearing leg first end, and wherein the second bracket linear surface extends linearly from the second curved surface.

8. The housing of claim 7,
wherein the first curved surface extends at a skewed angle to curve in the direction toward the second bearing leg first end, and
wherein the second curved surface extends at a skewed angle to curve in the direction toward the first bearing leg first end.

9. The housing of claim 7,
wherein the first bracket comprises two or more support frame mounting apertures below the pin receiving aperture and below the first curved surface, and
wherein the second bracket comprises two or more support frame mounting apertures below the pin receiving aperture and below the second curved surface.

10. The housing of claim 1, wherein the first bearing leg, the second bearing leg, and the bridge are the single integral component as formed from a single piece of sheet metal.

11. A solar tracker bearing system comprising:
a multi-leg solar tracker support frame comprising a first frame leg and a second frame leg;
a bearing housing comprising:
a first bearing leg comprising a first bearing leg first end and a first bearing leg second end, the first bearing leg first end including a first bracket that is configured to mount to the first frame leg,
a second bearing leg comprising a second bearing leg first end and a second bearing leg second end, the second bearing leg first end including a second bracket that is configured to mount to the second frame leg, and
a bridge extending between the first bearing leg second end and the second bearing leg second end, the bridge comprising a pin receiving aperture,
wherein the first bearing leg, the second bearing leg, and the bridge are a single integral component; and
a pin extending through the pin receiving aperture at the bridge.

12. The system of claim 11, further comprising:
a first rail at a first side of the bearing housing and coupled to the pin; and
a second rail at a second, opposite side of the bearing housing and coupled to the pin.

13. The system of claim 12, wherein the first rail is configured to support a torque tube at the first side of the bearing housing, and wherein the second rail is configured to support a torque tube at the second, opposite side of the bearing housing.

14. The system of claim 12, wherein the first bracket is integral to the first bearing leg and the second bracket is integral to the second bearing leg such that the first bearing leg, the first bracket, the second bearing leg, the second bracket, and the bridge are the single integral component.

15. The system of claim 14, wherein the pin couples the first rail to the bridge at the first side of the bearing housing and the pin couples the second rail to the bridge at the second, opposite side of the bearing housing such that the pin couples the first rail and the second rail to the single integral component.

16. The system of claim 11, wherein the first bracket defines a first bracket linear surface extending perpendicular to the bridge, wherein the second bracket defines a second bracket linear surface extending perpendicular to the bridge.

17. The system of claim 16, wherein the first bracket linear surface faces the second bracket linear surface, and wherein the first bracket linear surface extends parallel to the second bracket linear surface.

18. The system of claim 17,
wherein the pin receiving aperture is located at the bridge between the first bracket linear surface and the second bracket linear surface,
wherein the first bearing leg first end terminates at a first curved surface curving in a direction toward the second bearing leg first end, and wherein the first bracket linear surface extends linearly from the first curved surface, and
wherein the second bearing leg first end terminates at a second curved surface curving in a direction toward the first bearing leg first end, and wherein the second bracket linear surface extends linearly from the second curved surface.

19. The system of claim 18,
wherein the first bracket comprises two or more support frame mounting apertures below the pin receiving aperture and below the first curved surface, and
wherein the second bracket comprises two or more support frame mounting apertures below the pin receiving aperture and below the second curved surface.

20. The system of claim 19,
wherein the first rail comprises two or more solar module mounting apertures at or above the pin receiving aperture, and
wherein the second rail comprises two or more solar module mounting apertures at or above the pin receiving aperture.
